(19) United States
(12) Patent Application Publication
(10) Pub. No.: US 2023/0366821 A1
(43) Pub. Date: Nov. 16, 2023

(54) Multi-Spectral Imager for UV-Excited Tissue Autofluorescence Mapping

(71) Applicant: CytoVeris Inc., Farmington, CT (US)

(72) Inventors: David Fournier, Northborough, MA (US); Rishikesh Pandey, Unionville, CT (US)

(21) Appl. No.: 18/027,022

(22) PCT Filed: Sep. 17, 2021
(86) PCT No.: PCT/US2021/050991

§ 371 Date: Mar. 17, 2023

Related U.S. Application Data
(60) Provisional application No. 63/079,783, filed on Sep. 17, 2020.

(51) Int. Cl. G01N 21/64; G01N 21/47

(52) U.S. Cl. CPC G01N 21/6456; G01N 21/6486; G01N 21/4738; G01N 2021/6419; G01N 2021/6421; G01N 2021/6471; G01N 2223/401; G01N 2800/7028

(57) ABSTRACT

A method and system for analyzing a tissue sample is provided. The method includes: a) sequentially interrogating a tissue sample with excitation lights, wherein at least one of the excitation lights is configured to produce autofluorescence emissions from one or more biomolecules of interest, and diffuse reflectance signals from the tissue sample; b) using a photodetector to detect the autofluorescence emissions and/or the diffuse reflectance signals from the tissue sample, and to produce photodetector signals representative of the detected said autofluorescence emissions and/or the detected said diffuse reflectance signals; c) filtering the light emitted or reflected from the tissue sample; d) processing the photodetector signals for each sequential application of excitation light, including producing an image representative of the photodetector signals produced by each sequential application of excitation light; and e) analyzing the tissue sample using each image to identify the presence of diseased tissue within the tissue sample.

This application claims priority to U.S. Patent Appln. No. 63/079,783 filed Sep. 17, 2020, which is hereby incorporated by reference in its entirety.

### BACKGROUND OF THE INVENTION

### 1. Technical Field

The present disclosure relates to devices and methods for ex-vivo tissue analysis in general, and the devices and methods for detecting diseased tissue in an intraoperative procedure in particular.

### 2. Background Information

For many decades the reference method for the diagnosis of cancer has been histopathological examination of tissues using conventional microscopy. This process is known as surgical pathology. In surgical pathology, tissue samples can be produced from surgical procedures (tumor resection), diagnostic biopsies or autopsies. These tissue samples are subsequently subjected to a process that includes dissection, fixation, and cutting of tissue into precisely thin slices which are stained for contrast and mounted onto glass slides. The slides are examined by a pathologist under a microscope, and their interpretations of the tissue results in the pathology “read” of the sample.

Advanced optical and electromagnetic (“EM”) imaging approaches have been reported for the determination of tumor margin: These include the use of exogenous contrast-based fluorescence imaging [1, 2], near infrared spectroscopy [3], mass spectroscopy [4], terahertz reflectivity [5], Raman spectroscopy [6-12], hyperspectral imaging [13], autofluorescence life-time imaging [14], and the like.

Of these, techniques that do not require any exogenous dye or contrast agents are particularly appealing in an in-vivo setting. Optical spectroscopy, in particular, offer significant advantages to patients by avoiding potential toxicological issues, FDA approval of the contrast agents as drugs, the cost of the contrast agents and increased surgical time associated with administering imaging agents.

The endogenous fluorescence signatures offer useful information that can be mapped to the functional, metabolic and morphological attributes of a biological specimen, and have therefore been utilized for diagnostic purposes. Biomolecular changes occurring in the cell and tissue state during pathological processes and disease progression result in alterations of the amount and distribution of endogenous fluorophores and form the basis for classification. Tissue autofluorescence has been proposed to detect various malignancies including cancer by measuring either differential intensity or lifetimes of the intrinsic fluorophores. Biomolecules such as tryptophan, collagen, elastin, nicotinamide adenine dinucleotide (NADH), flavin adenine dinucleotide (FAD), porphyrins, etc. present in tissue provide discernible and repeatable autofluorescence spectral patterns. While tissue autofluorescence (AF) has been proposed for cancer detection, there are three major limitations for conventional autofluorescence-based diagnosis approaches: First, traditional autofluorescence assays typically use a single excitation wavelength which obviously does not excite all the intrinsic fluorophores present in the tissue. Consequently, it does not effectively utilize the comprehensive and rich biochemical information embedded in the tissue matrix both from cells and the extracellular matrix. Second, most of the applications involving autofluorescence use a fiber probe with single-point measurement capability and are inherently slow. Third, most of the autofluorescence approaches involve simpler data analysis such as calculating redox ratio or oxygenation index ratio, and do not utilize the rich morphological information. The imaging device and methods disclosed in this application addresses these concerns and offers a potentially transformative tissue analysis tool by utilizing biomolecule/biochemical and tissue microstructural information encoded in the autofluorescence and reflectance images.

### SUMMARY

According to an aspect of the present disclosure, a system for analyzing a tissue sample is provided that includes an excitation light unit, at least one photodetector, and a system controller. The excitation light unit is configured to selectively produce a plurality of excitation lights. Each excitation light is centered on a wavelength distinct from the centered wavelength of the other excitation lights. At least one of the excitation light centered wavelengths is configured to produce an autofluorescence emission from one or more biomolecules of interest, and a diffuse reflectance signal from the tissue sample. The at least one photodetector is configured to detect the autofluorescence emission, or the diffuse reflectance signal, or both from the tissue sample as a result of the respective incident excitation light, and to produce signals representative of the detected said autofluorescence emission, or the detected said diffuse reflectance signal, or both. The system controller is in communication with the excitation light unit, the at least one photodetector, and a non-transitory memory storing instructions, which instructions when executed cause the system controller to: a) control the excitation light unit to sequentially produce the plurality of excitation lights; b) receive and process the signals from the at least one photodetector for each sequential application of the plurality of excitation lights, and produce an image representative of the signals produced by each sequential application of the plurality of excitation lights; and c) analyze the tissue sample using a plurality of the images to identify the presence of diseased tissue within the tissue sample.

In any of the aspects or embodiments described above and herein, the excitation light unit may include a plurality of excitation light sources. Each excitation light source is configured to produce one of the excitation lights centered on a wavelength distinct from a respective centered wavelength of the other respective excitation lights.

In any of the aspects or embodiments described above and herein, the system may further include a first filter arrangement that is configured to filter the light emitted or reflected from the tissue sample resulting from each said sequential application of the plurality of excitation lights from each of the plurality of excitation light sources.

In any of the aspects or embodiments described above and herein, the first filter arrangement may include a plurality of bandpass filters and at least one of the plurality of bandpass filters is configured to selectively pass a portion of the light emitted or reflected from the tissue sample associated with the one or more biomolecules of interest.

In any of the aspects or embodiments described above and herein, the first filter arrangement may include a plurality of bandpass filters and at least one of the plurality of bandpass filters is configured to selectively pass a portion of the light emitted or reflected from the tissue sample associated with cellular or microstructural morphological information relating to the tissue sample.

In any of the aspects or embodiments described above and herein, the system may further include a second first filter arrangement that is configured to filter the excitation light produced from each of the plurality of excitation light sources.

In any of the aspects or embodiments described above and herein, the one or more biomolecules of interest are associated with cancer, and the cancer may be breast cancer, liver cancer, bladder cancer, colon cancer, or other cancers.

In any of the aspects or embodiments described above and herein, the instructions when executed cause the system controller to analyze the tissue sample using each image to identify the presence of diseased tissue within the tissue sample, and the analysis may include identifying the presence of the one or more biomolecules of interest.

In any of the aspects or embodiments described above and herein, the instructions when executed cause the system controller to analyze the tissue sample using each image to identify the presence of diseased tissue within the tissue sample, and the analysis may include providing cellular or microstructural morphological information.

In any of the aspects or embodiments described above and herein, the instructions when executed cause the system controller to analyze the analyze the tissue sample using each image to identify the presence of diseased tissue within the tissue sample, and the analysis may include using stored empirical data to evaluate the plurality of the images.

In any of the aspects or embodiments described above and herein, wherein system controller includes or is in communication with a classifier and the instructions when executed may cause the system controller to analyze the analyze the tissue sample using each image to identify the presence of diseased tissue within the tissue sample, the analysis may include using the classifier to evaluate the plurality of the images.

According to another aspect of the present disclosure, a method of analyzing a tissue sample is provided. The method includes: a) sequentially interrogating the tissue sample with a plurality of excitation lights, each excitation light centered on a wavelength distinct from the centered wavelength of the other excitation lights, wherein at least one of the excitation light centered wavelengths is configured to produce autofluorescence emissions from one or more biomolecules of interest, and a diffuse reflectance signals from the tissue sample; b) using at least one photodetector to detect the autofluorescence emissions, or the diffuse reflectance signals, or both from the tissue sample, and to produce photodetector signals representative of the detected said autofluorescence emissions, or the detected said diffuse reflectance signals, or both; c) processing the photodetector signals for each sequential application of the plurality of excitation lights, including producing an image representative of the photodetector signals produced by each sequential application of the plurality of excitation lights; and d) analyzing the tissue sample using each image to identify the presence of diseased tissue within the tissue sample.

In any of the aspects or embodiments described above and herein, the method may include filtering the light emitted or reflected from the tissue sample resulting from each said sequential interrogation of the tissue sample.

In any of the aspects or embodiments described above and herein, wherein the filtering step includes filtering the light emitted or reflected from the tissue sample to selectively pass a portion of the light emitted or reflected from the tissue sample associated with the one or more biomolecules of interest.

In any of the aspects or embodiments described above and herein, wherein the filtering step includes filtering the light emitted or reflected from the tissue sample to selectively pass a portion of the light emitted or reflected from the tissue sample associated with cellular or microstructural morphological information relating to the tissue sample.

In any of the aspects or embodiments described above and herein, the method may include filtering each of the excitation lights prior to each respective said excitation light interrogating the tissue sample.

In any of the aspects or embodiments described above and herein, wherein the one or more biomolecules of interest may be associated with a type of cancer.

In any of the aspects or embodiments described above and herein, wherein the analyzing step may include identifying the presence of the one or more biomolecules of interest.

In any of the aspects or embodiments described above and herein, wherein the analyzing step may include providing cellular or microstructural morphological information.

In any of the aspects or embodiments described above and herein, wherein the analyzing step may include using stored empirical data to evaluate the plurality of the images.

In any of the aspects or embodiments described above and herein, wherein the analyzing step may include using a classifier to evaluate the plurality of the images.

In any of the aspects or embodiments described above and herein, wherein the tissue sample may be a breast tissue biopsy.

In any of the aspects or embodiments described above and herein, the tissue sample may be an ex-vivo sample produced during intraoperative surgery, or the tissue sample may be a tissue biopsy, or the tissue sample may be used in conjunction with a mammogram for tissue biopsy diagnosis, or the tissue sample may be used for triaging surgical specimens in a pathological setting.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a diagrammatic illustration of an optical system embodiment according to the present disclosure.

FIG. 2 is an illustration of a tissue sample on a stainless-steel substrate.

FIG. 3 is a diagrammatic illustration of an optical system embodiment according to the present disclosure.

FIG. 4 is a table of excitation/illumination wavelengths versus reflectance/fluorescence wavelengths.

FIG. 5 is a graph of fluorescence intensity versus fluorescence emission wavelength, illustrating diagrammatic representations of biomolecule curves.

FIG. 6 is a graph of percentage transmission versus wavelength, illustrating multiple excitation wavelengths filtered by a single bandpass filter.

### DISCLOSURE OF THE INVENTION

Aspects of the present disclosure include a novel and unobvious multi-spectral imaging system and method for analyzing a tissue sample. The present disclosure may be used to analyze a tissue sample for purposes of providing information regarding whether the tissue sample is normal (e.g., “healthy”) or abnormal, and therefore potentially in a diseased state (e.g., cancerous). It can also be used to detect and differentiate different types of the malignancies and their grades/stages of a malignancy type. The present disclosure has particular utility in analyzing tissue sample for breast cancer analysis. The present disclosure is not however limited for use with breast cancer detection; e.g., other nonlimiting uses include tissue analysis for liver cancer, bladder cancer, colon cancer to name a few. In addition, the methods and systems disclosed here can be used to differentiate and detect different normal tissue types and can also be used to measure characteristics of a normal tissue such as metabolite state, density etc.

The system includes an excitation light unit, one or more optical filters, one or more photodetectors, and a system controller. In some embodiments, the system may include other components such as one or more of a filter controller, a tunable optical filtering device, a scanning device, an optical switch, an optical splitter, and the like.

The excitation light unit is configured to produce excitation light centered at a plurality of different wavelengths. As will be detail below, the term “excitation light unit” as used herein is not limited to a light source configured to produce AF emissions but is also able to produce reflectance signal. Exλmples of an acceptable excitation light source include lasers and light emitting diodes (LEDs) each centered at a different wavelength, or a tunable excitation light source configured to selectively produce light centered at respective different wavelengths, or a source of white light (e.g., flash lamps) that may be selectively filtered to produce the aforesaid excitation light centered at respective different wavelengths. This disclosure is not limited to any particular type of excitation light unit. The wavelengths produced by the excitation light unit are typically chosen based on the photometric properties associated with one or more biomolecules of interest. Excitation light incident to a biomolecule that acts as a fluorophore will cause the fluorophore to emit fluorescent light at a wavelength longer than the wavelength of the excitation light; i.e., via AF. Tissue may naturally include certain fluorophores such as tryptophan, collagen, elastin, nicotinamide adenine dinucleotide (NADH), flavin adenine dinucleotide (FAD), porphyrins, and the like. Biomolecular changes occurring in the cell and tissue state during pathological processes and as a result of disease progression often result in alterations of the amount and distribution of these endogenous fluorophores. Hence, diseased tissues such as cancerous tissue, due to the marked difference in cell-cycle and metabolic activity can exhibit distinct intrinsic tissue AF, or in other words an “AF signature” that is identifiable. Embodiments of the present disclosure may utilize these AF characteristics/signatures to identify regions of diseased tissue such as cancerous tissue. Different types of diseased tissue (e.g., different types of cancerous tissue) and diseases tissue of different organs for instance breast and liver cancers may have different biomolecules/biochemicals associated therewith and the present disclosure is not therefore limited to any particular biomolecule or any particular cancer type. Excitation wavelengths are also chosen that cause detectable light reflectance from tissue of interest. The detectable light reflectance is a function of light absorption of the tissue and/or light scattering associated with the tissue (this may be collectively referred to as diffuse reflectance). Certain tissue types or permutations thereof have differing and detectable light reflectance characteristics (“signatures”) at certain wavelengths. Significantly, these reflectance characteristics can provide information beyond intensity; e.g., information relating to cellular or microcellular structure such as cell nucleus and extracellular components. The morphology of a healthy tissue cell may be different from that of an abnormal or diseased tissue cell. Hence, the ability to gather cellular or microstructural morphological information (sometimes referred to as “texture”) provides another tool for determining tissue types and the state and characteristics of such tissue. The excitation light source may be configured to produce light at wavelengths in the ultraviolet (UV) region (e.g., 100-400 nm) and in some applications may include light in the visible region (e.g., 400-700 nm). The excitation lights are chosen based on the absorption characteristics of the biomolecules of interest.

The present disclosure may utilize a variety of different photodetector types configured to sense light and provide signals that may be used to measure the same. Non-limiting examples of an acceptable photodetector include those that convert light energy into an electrical signal such as photodiodes, avalanche photodiodes, a CCD array, an ICCD, a CMOS, or the like. The photodetector may take the form of a camera. As will be described below, the photodetector(s) are configured to detect AF emissions from the interrogated tissue and/or diffuse reflectance from the interrogated tissue and produce signals representative of the detected light and communicate the signals to the system controller.

The system controller is in communication with other components within the system, such as the excitation light source and one or more photodetectors. In some system embodiments, the system may also be in communication with one or more of a: filter controller, a tunable optical filtering device, an optical switch, an optical splitter, and the like as will be described below. The system controller may be in communication with these components to control and/or receive signals therefrom to perform the functions described herein. The system controller may include any type of computing device, computational circuit, processor(s), CPU, computer, or the like capable of executing a series of instructions that are stored in memory. The instructions may include an operating system, and/or executable software modules such as program files, system data, buffers, drivers, utilities, and the like. The executable instructions may apply to any functionality described herein to enable the system to accomplish the same algorithmically and/or coordination of system components. The system controller includes or is in communication with one or more memory devices. The present disclosure is not limited to any particular type of memory device, and the memory device may store instructions and/or data in a non-transitory manner. Exλmples of memory devices that may be used include read-only memory, random access memory, volatile memory, non-volatile memory, static memory, dynamic memory, flash memory, cache memory, and/or any device that stores digital information. The system controller may include, or may be in communication with, an input device that enables a user to enter data and/or instructions, and may include, or be in communication with, an output device configured, for example to display information (e.g., a visual display or a printer), or to transfer data, etc. Communications between the system controller and other system components may be via a hardwire connection or via a wireless connection.

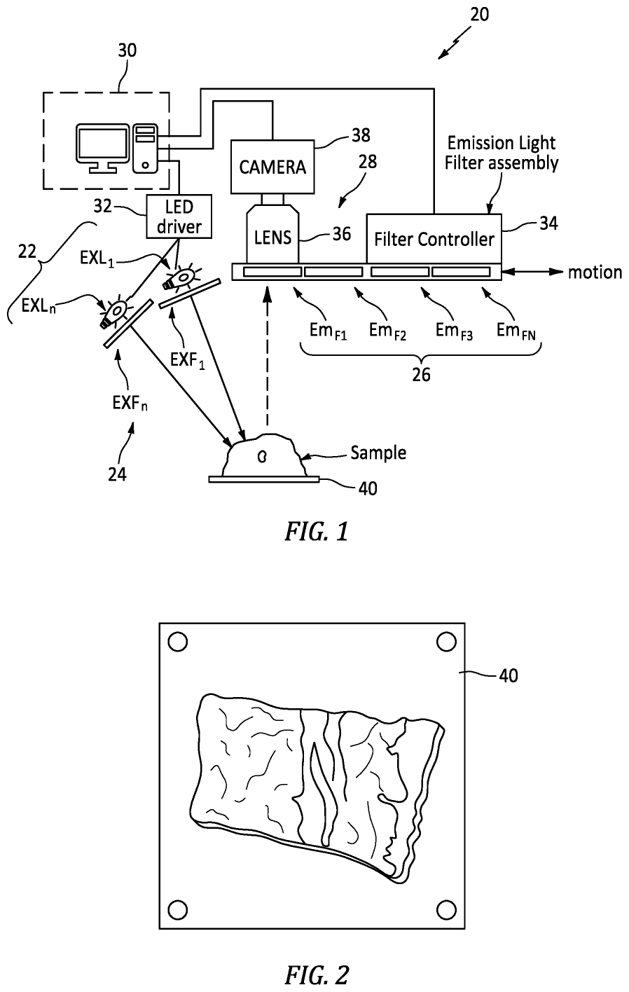

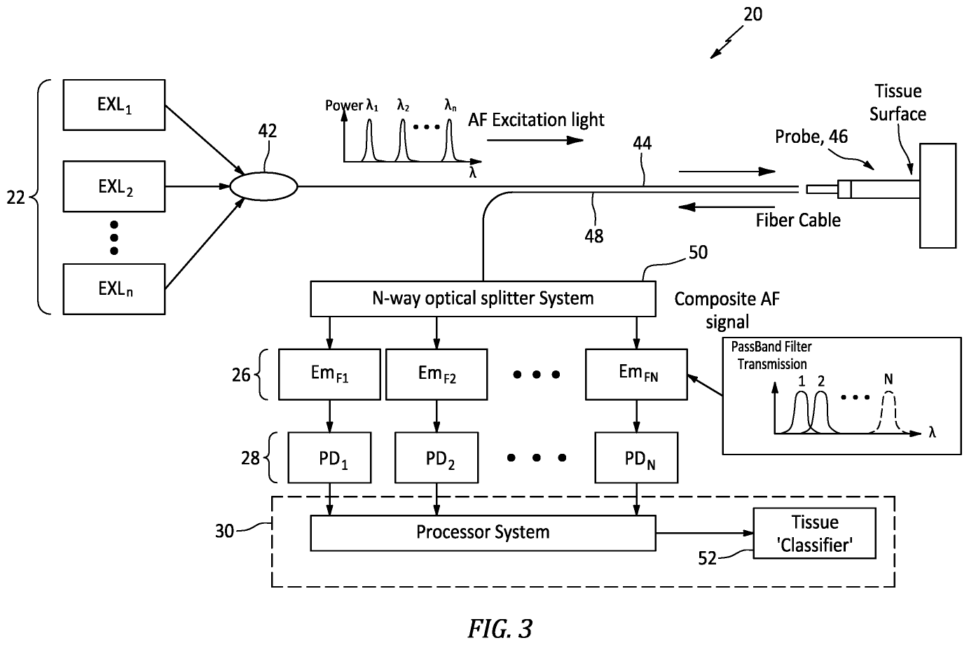

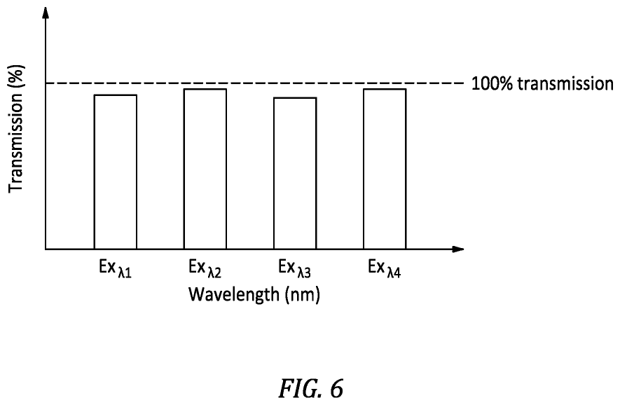

Embodiments of the present disclosure may include optical filtering elements configured to filter excitation light, or optical filtering elements configured to filter emitted light (including reflected light), or both. Each optical filtering element is configured to pass a defined bandpass of wavelengths associated with an excitation light source or emitted/reflected light (e.g., fluorescence or reflectance), and may take the form of a bandpass filter. In regard to filtering excitation light, the system may include an independent filtering element associated with each independent excitation light source or may include a plurality of filtering elements disposed in a movable form (e.g., a wheel or a linear array configuration) or may include a single filtering element that is operable to filter excitation light at a plurality of different wavelengths (e.g., see FIG. 6), or each excitation light source may be configured to include a filtering element, or the like. In regard to filtering emitted light, the system may include a plurality of independent filtering elements each associated with a different bandwidth or may include a plurality of filtering elements disposed in a movable form or may include a single filtering element that is operable to filter emitted/reflected light at a plurality of different wavelengths (e.g., see FIG. 6), or the like. The bandwidth of the emitted/reflected light filters are typically chosen based on the photometric properties associated with one or more biomolecules of interest. Certain biomolecules may have multiple emission or reflectance peaks. The bandwidth of the emitted/reflected light filters are typically chosen to allow only emitted/reflected light from a limited portion of the biomolecule emission/reflectance response; i.e., a portion of interest that facilitates the analysis described herein. The exemplary system embodiments shown in FIGS. 1 and 3 illustrate non-limiting examples of optical filtering. In some embodiments, the system may include a tunable bandpass filter that is controllable to provide a plurality of different bandwidth filtration modes. In certain embodiments, the excitation filter may be disposed or integrated as a part of excitation light source. For example, the LED or other light source can be coated with a material to allow desired bandpass.

An exemplary embodiment of a present disclosure system 20 is diagrammatically illustrated in FIG. 1. This system 20 embodiment includes an excitation light source 22, an excitation light filter arrangement 24, an emission/reflectance light filter assembly 26, a photodetector arrangement 28, and a system controller 30. The excitation light source 22 includes a plurality of independent excitation light sources (e.g., EXL₁ . . . EXLₙ, where “n” is an integer greater than one), each operable to produce an excitation light centered at a particular wavelength and each centered on an excitation wavelength different from the others. The independent excitation light sources are directly or indirectly in communication with the system controller 30. In this example, the independent excitation light sources are UV LEDs. As described above, the wavelengths produced by the independent excitation light sources are chosen based on the photometric properties associated with biomolecules/tissue types of interest. The LEDs are in communication with an LED driver 32 that may be independent of the system controller 30 or the functionality of the LED driver 32 may be incorporated into the system controller 30. The excitation light filter arrangement 24 shown in FIG. 1 includes an independent bandpass filter (EXF₁ . . . EXFₙ) for each excitation light source and the bandwidth filter properties for each independent bandpass filter are tailored for the respective excitation light source with which it is associated. In alternative embodiments the system 20 may be configured without an excitation light filter arrangement, or each excitation light source may have an incorporated filter element, or the system 20 may include an excitation filter arrangement with a movable filter element (e.g., a wheel, linear array, etc.), or may include a single filtering element that is operable to filter excitation light at a plurality of different wavelengths (e.g., see FIG. 6). The system 20 embodiment diagrammatically shown in FIG. 1 includes an emission light filter assembly 26 having a filter controller 34 and a linear array of bandpass filters (e.g., Em_{F1}, Em_{F2} . . . Em_{FN}). The filter controller 34 is configured to selectively position each respective bandpass filter in a light path between the tissue sample (i.e., the source of the emitted/reflected light) and the photodetector arrangement 28 to permit filtering of the emitted/reflected light prior to detection by the photodetector arrangement 28. The filter controller 34 may be in communication with the system controller 30, or the filter controller 34 functionality may be incorporated into the system controller 30. As stated above, the bandwidth of the respective bandpass filters for the emitted/reflected light are typically chosen based on the photometric properties associated with one or more biomolecules of interest; e.g., to allow only emitted/reflected light from a limited portion of the biomolecule emission/reflectance response that is of interest to facilitate the analyses described herein. The photodetector arrangement 28 includes a lens arrangement 36 and a camera 38. The lens arrangement 36 is configurable to suit the application at hand. For example, in some embodiments the lens arrangement 36 may include a single fixed focus lens. In some embodiments, the lens arrangement 36 may be configured to address chromatic dispersion. For example, the lens arrangement 36 may include one or more corrective lenses configured to address aberration/focus as may be desired. In some embodiments, the lens arrangement 36 may be controllable to selectively change lens configurations and is in communication with the system controller 30. The camera 38 is configured to produce signals representative of the sensed emitted light passed through the emission light filter assembly 26. The aforesaid signals may be referred to as an “image” or may be processed into an image. The camera 38 is in communication with the system controller 30.

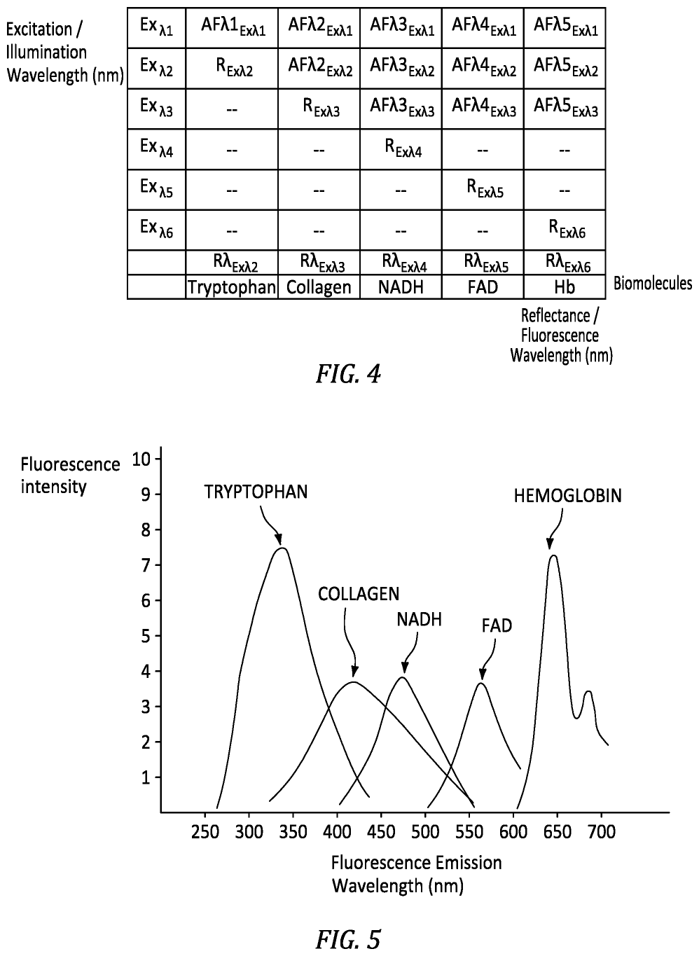

In the operation of the system 30 embodiment diagrammatically shown in FIG. 1, an excised tissue sample (e.g., see FIG. 2) may be placed on a stage 40 or other platform at a position optically aligned with the photodetector arrangement 28. In some instances, the system 20 and/or the tissue sample may be such that the entirety of the sample can be imaged without changing the relative positions of the tissue sample and the system optics. In other instances, wherein the system 20 is not configured to image the entirety of the tissue sample, the system 20 may be configured to move one or both of the tissue sample and the system optics relative to one another so multiple regions of the tissue sample may be imaged; e.g., the tissue sample may be scanned. The images from the respective regions may subsequently be “stitched” together to form one or more images of the entirety of the tissue sample. In some instances, the stage 40 may include a plurality of fiduciary markers to facilitate registration between images. The system controller 30 (through stored instructions) is configured to sequentially operate the independent excitation light sources (e.g., EXL₁ . . . EXLₙ). As each excitation light source is operated, the produced excitation light passes through an excitation light filter prior to being incident to the tissue sample. If a fluorophore of interest is present within the tissue sample and that fluorophore is responsive to the wavelength of the incident excitation light, the excitation light will cause the fluorophore to produce an AF emission at a wavelength that is different from the excitation wavelength. Excitation light centered on a particular wavelength may produce AF emissions from more than one fluorophore of interest. Referring to the table in FIG. 4, a first excitation wavelength (EXλ1) can produce AF emissions at several different wavelengths (AFλ1_{EXλ1}, AFλ2_{EXλ1}, AFλ3_{EXλ1}, AFλ4_{EXλ1}, AFλ5_{EXλ1}). The same excitation light incident to the tissue sample may also generate diffuse reflectance signals; i.e., excitation light that is reflected from the tissue sample. For example, and again referring to the table in FIG. 4, a second excitation wavelength (EXλ2) can produce reflectance signals (R_{EXλ2}) and AF emissions at several different wavelengths (AFλ2_{EXλ2}, AFλ3_{EXλ2}, AFλ4_{EXλ2}, AFλ5_{Exλ2}), a third excitation wavelength (EXλ3) can produce reflectance signal (R_{EXλ3}) and AF emissions at several different wavelengths (AFλ3_{EXλ3}, AFλ4_{EXλ3}, AFλ5_{EXλ4}), and so on. The emission/reflectance light filter assembly 26 is controlled to coordinate placement of a particular bandpass filter in alignment with the camera 38, which bandpass filter is appropriate for the excitation light source being operated and to produce a limited bandwidth of the emitted/reflected light that is of interest for the analysis at hand; e.g., associated with particular biomolecules of interest. Some amount of the emitted light passes through the bandpass filter, is sensed by the camera 38, and the camera 38 produces signals representative of the sensed emitted/reflected light. The aforesaid signals may be referred to as an image or may be processed into an image. In some applications, an excitation wavelength may be chosen only for AF emissions of interest (e.g., EXλ1 in FIG. 4), and/or an excitation wavelength may be chosen only for diffuse reflectance signals of interest (e.g., EXλ4, EXλ5, and EXλ6 in FIG. 4). The above described process is repeated until the sample has been examined using all of the desired wavelengths of excitation light. As will be detailed below, the respective images may be used to collectively identify biomolecules/tissue types of interest with a desirable degree of specificity and sensitivity.

FIG. 3 diagrammatically illustrates another exemplary embodiment of a present disclosure system 20. This system 20 embodiment includes an excitation light source 22, an optical switch 42, one or more first optical fibers 44, a probe 46, one or more second optical fibers 48, an emission light filter assembly 26, a photodetector arrangement 28, and a system controller 30. The excitation light source 22 includes a plurality of independent excitation light sources (e.g., EXL₁ . . . EXLₙ, where “n” is an integer greater than one), each operable to produce an excitation light centered at a particular wavelength and each centered on an excitation wavelength different from the others. Each of the plurality of independent excitation light sources produces excitation light centered on a different wavelength. The respective excitation wavelengths are chosen based on either native tissue fluorophores that may be present within diseased tissue and the significance of those fluorophores relative to diseased tissue or based on the reflectance characteristics of certain tissue types and the significance of those tissue types relative to diseased tissue, or both. In other words, excitation wavelengths may be chosen that are known to produce identifiable AF emissions from native fluorophores having emission characteristics (e.g., intensity, density of signal within a given area, etc.) that provide information regarding the presence of diseased tissue (e.g., cancerous tissue) and/or to produce identifiable reflectance emissions from the tissue sample having characteristics that provide information regarding the presence of diseased tissue. The independent excitation light sources are in direct or indirect communication with the system controller 30. In this example, the independent excitation light sources are UV LEDs. The LEDs may be in communication with an LED driver that may be independent of the system controller 30 or the functionality of the LED driver may be incorporated into the system controller 30. As stated above with regard to the system 20 embodiment diagrammatically shown in FIG. 1, system 20 embodiments may be configured to image the entirety of the tissue sample without changing the relative positions of the tissue sample and the system optics, or the system 20 may be configured to move one or both of the tissue sample and the system optics so multiple regions of the tissue sample may be imaged. The system 20 embodiment diagrammatically shown in FIG. 3 includes a probe 46 representing a tissue sample scanning embodiment. The emission light filter assembly 26 includes a plurality of narrow bandpass filters (e.g., Em_{F1}, Em_{F2}, . . . Em_{FN}, where “N” is an integer greater than one). Each narrow bandpass filter may be centered at a wavelength in the UV/visible/NIR region, which wavelength is different from those of the other narrow bandpass filters. The photodetector arrangement 28 includes a plurality of photodetectors (e.g., PD₁, PD₂, . . . PD_{N}). Each photodetector may be chosen to provide optimal performance at the wavelength of light passed by the respective narrow bandpass filter, and at low intensity levels. In some embodiments, the light intensity monitored at each photodetector can be integrated for a time duration (“T”) to increase the effective signal to noise ratio (“SNR”). Each respective photodetector produces signals representative of the filtered emitted light, and those signals are communicated to the system controller 30.

In the operation of the system 20 embodiment diagrammatically shown in FIG. 3, an excised tissue sample is positioned for examination. The excitation light sources (e.g., EXL₁, EXL₂ . . . EXLₙ) are sequentially operated to produce excitation light and that light is passed to the optical switch 42. The one or more first optical fibers 44 transfer the excitation light from the optical switch 42 to the probe 46. The probe 46 may be used to scan the surface of the tissue sample with the excitation light. The scanning involves applying excitation light to and collecting emitted light from at least a portion of the tissue sample, and typically substantially all of the tissue sample. Light emitted/reflected (e.g., AF and diffuse reflectance) as a result of the excitation light interrogation of the tissue sample is collected and transferred to an optical splitter 50 by the one or more second optical fibers 48. The optical splitter 50, in turn, splits the collected emitted light into “N” portions and passes it into “N” channels. Each portion of the collected emitted light is passed to a narrow bandpass filter (Em_{F1}, Em_{F2} . . . Em_{FN}) of the emission light filter assembly 26. The emitted light portion passes through the respective narrow bandpass filter and is directed to a respective photodetector (e.g., PD₁, PD₂ . . . PD_{N}) of the photodetector arrangement 28. Each respective photodetector produces signals representative of the filtered emitted light, and those signals are communicated to the system controller 30. The above described process (e.g., every excitation wavelength) is repeated at every scanned tissue sample region until the sample has been examined using all of the desired wavelengths of excitation light. As will be detailed below, the respective images representative of the emitted light may be used to collectively identify biomolecules/tissue types of interest with a desirable degree of specificity and sensitivity.

It should be noted that the present disclosure system embodiments diagrammatically illustrated in FIGS. 1 and 3 are provided as non-limiting illustrations. System 20 embodiments may include various other system components such as additional optical filters; e.g., to limit optical interference of other scattered light, or to block excitation light from a detection path, or for other optical function, and any combination thereof.

In some system 20 embodiments, a tunable excitation light source configured to selectively produce light centered at a plurality of different wavelengths as an alternative to the plurality of AF excitation light sources. The tunable excitation light source may be operated to sequentially produce each of the respective excitation wavelengths.

In the system 20 embodiments described above and others, the signals (i.e., image) representative of the emitted light (AF and/or reflectance) captured by the photodetector arrangement 28 (e.g., camera or plurality of photodetectors) for each excitation light wavelength collectively provide a mosaic of information relating to the tissue sample. The chart shown in FIG. 4 illustrates an exemplary scenario wherein five (5) different excitation light sources, each centered on a different wavelength (i.e., Ex_{λ1}, Ex_{λ2}, Ex_{λ3}, Ex_{λ4}, Ex_{λ5}, and Ex_{λ6} nm), are used within the system 20. Depending on the presence of certain fluorophores within the tissue sample, the first excitation wavelength (i.e., Ex_{λ1}) may produce AF emissions of interest at five (5) different wavelengths (AFλ1_{Exλ1}, AFλ2_{Exλ1}, AFλ3_{Exλ1}, AFλ4_{Exλ1}, AFλ5_{Exλ1}), and the second excitation wavelength (i.e., Ex_{λ2}) may produce AF emissions of interest at four (4) different wavelengths (AFλ2_{Exλ2}, AFλ3_{Exλ2}, AFλ4_{Exλ2}, AFλ5_{Exλ2}), and so on. The second excitation wavelength (i.e., Ex_{λ2}) may also produce a reflectance image at this wavelength (R_{Exλ2}) that is a useful indicator of the presence or absence of certain tissue types within the tissue sample. The Ex_{λ4}, Ex_{λ5}, and Ex_{λ6} excitation wavelengths may not be used to produce AF emissions of interest, but each may be used to produce a reflectance image of interest (i.e., R_{Exλ4}, R_{Exλ5}, R_{Exλ6}). As can be seen from the example shown in FIG. 4, the six (6) excitation wavelengths (i.e., Ex_{λ1}, Ex_{λ2}, Ex_{λ3}, Ex_{λ4}, Ex_{λ5}, and Ex_{λ6} nm) may be used to produce seventeen emitted light images (AFλ1_{Exλ1}, AFλ2_{Exλ1}, AFλ3_{Exλ1}, AFλ4_{Exλ1}, AFλ5_{Exλ1}, R_{Exλ2}, AFλ2_{Exλ2}, AFλ3_{Exλ2}, AFλ4_{Exλ2}, AFλ5_{Exλ2}, R_{Exλ3}, AFλ3_{Exλ3}, AFλ4_{Exλ3}, AFλ5_{Exλ3}, R_{Exλ4}, R_{Exλ5}, R_{Exλ6}) that may be used collectively to identify biomolecule/tissue types of interest with a desirable degree of specificity and sensitivity. It should be noted that the number of excitation wavelengths, the number of reflectance wavelengths, the biomolecule, and the particular AF emissions selected, and reflectance emissions indicated in FIG. 4 are provided to illustrate the present disclosure, and the present disclosure is not limited to this example. For example, the analysis of different types of cancer or other diseased tissue may benefit from fewer or more excitation wavelengths, different biomolecule, etc.

The integrated information provided by the aforesaid emitted light images provide distinct benefits in the process of identifying biomolecule/tissue types of interest with a desirable degree of specificity and sensitivity. As can be seen from FIG. 5, AF emissions are produced in a peaked band with an intensity value that is centered on a particular wavelength. Hence, AF emissions centered on a particular wavelength will include AF emissions not only on the peak wavelength but also on adjacent wavelengths albeit at a lesser intensity. As can also be seen in FIG. 5, the biomolecule/fluorophores of interest (e.g., tryptophan, collagen, NADH, FAD, hemoglobin, etc.) have characteristic AF intensity curves with a peak centered on a wavelength but also including lesser intensities at wavelengths adjacent the peak wavelength. The AF intensity curves of some of the biomolecules may overlap to a degree. As a result, AF emissions at a particular wavelength within the overlap region may be a product of AF emissions from a first biomolecule or from a second biomolecule and are likely not dispositive by themselves of either biomolecule. As indicated above, at least some biomolecule of interest also have reflectance curves (indicating the amount of light reflectance which is a function of light absorption of the tissue and light scattering within the tissue) with a peak centered on a peak wavelength but also including lesser intensities at wavelengths adjacent the peak wavelength. The reflectance curves of some of the biomolecules may also overlap to a degree. As a result, reflectance at a particular wavelength within the overlap region may be a product of reflectance from a first biomolecule or from a second biomolecule and is likely not dispositive by itself of either biomolecule. In addition, as indicated above, reflectance images can also provide cellular or tissue microstructrual information that can be used as an additional tool for determining tissue types and the state of such tissue. The collective information provided by the aforesaid plurality of emitted/reflected light images produced by the present disclosure system 20, however, provides distinct information at different excitation wavelengths that can be used to identify biomolecule/tissue types with a desirable degree of specificity and sensitivity. In some embodiments, the system controller 30 (via stored instructions) may utilize a stored empirical database during the analysis of the tissue sample. A clinically significant number of stored AF and/or reflectance images of known tissue types (e.g., adipose, cancerous tissue, benign tissue, etc.) may be used to comparatively analyze the emitted light images (AF and/or reflectance) collected from the tissue sample at the various different excitation wavelengths. The aforesaid analysis may utilize one or more stored algorithms, and those algorithms may apply weighing factors, or corrective factors, or the like. In some embodiments, reflectance signals/images may be used directly in a classifier and/or to correct AF images.

In some embodiments, the stored instructions within the system controller 30 may include an artificial intelligence/machine learning (AI/ML) algorithm trained classifier 52 (e.g., see FIG. 3) that is “trained” using a clinically significant number of images of known tissue types (e.g., adipose, cancerous tissue, benign tissue, etc.) collected at the respective excitation wavelengths. The trained classifier in turn may be used to evaluate the acquired light images (AF and/or reflectance) collected from the tissue sample at the various different excitation wavelengths to determine the presence or absence of biomolecule/tissue types indicative of diseased tissue (e.g., cancerous tissue). A dictionary learning, anomaly detector, convolutional neural network (CNN) or a random forest type classifier are examples algorithms that may be used. The present disclosure is not limited to these examples.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details. For example, the present disclosure has been described above in terms of analyzing tissue samples suspected to include cancerous tissue associated with, for example, breast cancer, liver cancer, bladder cancer, colon cancer, and the like. The present disclosure also provides considerable utility with procedures associated with detecting and treating the same. For example, the tissue sample may be an ex-vivo sample produced during intraoperative surgery, or the tissue sample may be a tissue biopsy, or the tissue sample may be produced and analyzed in conjunction with mammogram for a tissue biopsy diagnosis, or the tissue sample may be used for triaging surgical specimens in a pathological setting, or the like. The aforesaid are non-limiting examples of applications of the present disclosure.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

### REFERENCES

The following references are hereby incorporated by reference in their respective entireties:
1. Nguyen and Tsien, “Fluorescence-guided surgery with live molecular navigation a new cutting edge”, Nat Rev Cancer, 13(9), pp. 653-662, 2013.
2. Tummers, et al., “Real-time intraoperative detection of breast cancer using near-infrared fluorescence imaging and methylene blue”, Eur J Surg Oncol., 40(7), 850-858, 2014.
3. Dahr et al., “A diffuse reflectance spectral imaging system for tumor margin assessment using custom annular photodiode arrays”, Biomedical Optics Express, 3, (12), 2012.
4. Hanel et al., “Mass spectroscopy-based interoperative tumor diagnostics”, Future Sci OA, 5(3), 2019 March
5. Yaroslavsky. A, et al., “Delineating nonmelanoma skin cancer margins using terahertz and optical imaging”, J of Biomedical Photonics & Eng., 3(1), 2017.
6. Pence I., Mahadevan-Jansen A., “Clinical instrumentation and applications of Raman spectroscopy”, Chem Soc Rev.; 45 (7):1958-1979, 2016.
7. Talari, A. et al., “Raman Spectroscopy of Biological Tissues”, Applied Spectroscopy Reviews, 50:1, 46-111, 2015.
8. A. S. Haka, et al, “In vivo margin assessment during partial mastectomy breast surgery using Raman spectroscopy,” Cancer Res. 66(6), 3317-3322 (2006).
9. J. Mo, et al., “High wavenumber Raman spectroscopy for in vivo detection of cervical dysplasia,” Anal. Chem. 81(21), 8908-8915 (2009).
10. K. Lin, et al., “Optical diagnosis of laryngeal cancer using high wavenumber Raman spectroscopy,” Biosens. Bioelectron. 35(1), 213-217 (2012).
11. Aubertin et al., “Combining high wavenumber and fingerprint Raman spectroscopy for the detection of prostate cancer during radical prostatectomy”, 9, (9), Biomedical Optics Express, p. 4294, (2018)
12. R. Pandey et al, “Raman spectroscopy based molecular barcoding: realizing the value of high wavenumber region in breast cancer detection”, Proc. SPIE 11631, Advanced Biomedical and Clinical Diagnostic and Surgical Guidance Systems XIX, 1163105 (5 Mar. 2021).
13. Kho et al., “Hyperspectral Imaging for resection Margin Assessment during Cancer Surgery”, Clin Cancer Res; 25(12), Jun. 15, 2019.
14. Gorpas et al., “Autofluorescence lifetime augmented reality as a means for real-time robotic surgery guidance in human patients”, Sci Rep 9, 1187 (2019).

1. A system for analyzing a tissue sample, comprising:
an excitation light unit configured to selectively produce a plurality of excitation lights, each said excitation light centered on a wavelength distinct from the centered wavelength of the other said excitation lights, wherein at least one of the excitation light centered wavelengths is configured to produce autofluorescence emissions from one or more biomolecules of interest, and a diffuse reflectance signals from the tissue sample, the system configured so that the plurality of excitation lights are incident to the tissue sample;
at least one photodetector configured to detect the autofluorescence emissions, or the diffuse reflectance signals, or both from the tissue sample as a result of the respective incident excitation light, and produce signals representative of the detected said autofluorescence emissions, or the detected said diffuse reflectance signals, or both;
at least one optical filter operable to filter the signals representative of the detected said autofluorescence emissions, or the detected said diffuse reflectance signals, or both;
a system controller in communication with the excitation light unit, the at least one photodetector, and a non-transitory memory storing instructions, which instructions when executed cause the system controller to:
control the excitation light unit to sequentially produce the plurality of excitation lights;
receive and process the signals from the at least one photodetector for each sequential application of the plurality of excitation lights, and produce an image representative of the signals produced by each sequential application of the plurality of excitation lights; and
analyze the tissue sample using a plurality of the images to identify the presence of diseased tissue within the tissue sample.

2. The system of claim 1, wherein the excitation light unit includes a plurality of excitation light sources, each said excitation light source is configured to produce one of said excitation lights centered on said wavelength distinct from the respective centered wavelength of the other respective said excitation lights.

3. The system of claim 2, further comprising a first filter arrangement configured to filter the light emitted or reflected from the tissue sample resulting from each said sequential application of the plurality of excitation lights from each of the plurality of excitation light sources.

4. The system of claim 3, wherein the at least one optical filter includes a first filter arrangement includes a plurality of bandpass filters and at least one of the plurality of bandpass filters is configured to selectively pass a portion of the light emitted or reflected from the tissue sample associated with the one or more biomolecules of interest.

5. The system of claim 3, wherein the first filter arrangement includes a plurality of bandpass filters and at least one of the plurality of bandpass filters is configured to selectively pass a portion of the light emitted or reflected from the tissue sample associated with cellular or microstructural morphological information relating to the tissue sample.

6. The system of claim 3, wherein the at least one optical filter includes a second filter arrangement configured to filter the excitation light produced from each of the plurality of excitation light sources.

7. The system of claim 1, wherein the one or more biomolecules of interest are associated with cancer.

8. The system of claim 7, wherein the cancer is one or more of breast cancer, liver cancer, bladder cancer, or colon cancer.

9. The system of claim 1, wherein the instructions when executed cause the system controller to analyze the tissue sample using each image to identify the presence of diseased tissue within the tissue sample, the analysis including identifying the presence of the one or more biomolecules of interest.

10. The system of claim 1, wherein the instructions when executed cause the system controller to analyze the tissue sample using each image to identify the presence of diseased tissue within the tissue sample, the analysis including providing cellular or microstructural morphological information.

11. The system of claim 1, wherein the instructions when executed cause the system controller to analyze the analyze the tissue sample using each image to identify the presence of diseased tissue within the tissue sample, the analysis including using stored empirical data to evaluate the plurality of the images.

12. The system of claim 1, wherein system controller includes or is in communication with a classifier and the instructions when executed cause the system controller to analyze the analyze the tissue sample using each image to identify the presence of diseased tissue within the tissue sample, the analysis including using the classifier to evaluate the plurality of the images.

13. The system of claim 1, wherein the tissue sample is an ex-vivo sample produced during an intraoperative surgery.

14. The system of claim 1, wherein the tissue sample is a tissue biopsy.

15. A method of analyzing a tissue sample, comprising:
sequentially interrogating the tissue sample with a plurality of excitation lights, each excitation light centered on a wavelength distinct from the centered wavelength of the other excitation lights, wherein at least one of the excitation light centered wavelengths is configured to produce autofluorescence emissions from one or more biomolecules of interest, and a diffuse reflectance signals from the tissue sample;
using at least one photodetector to detect the autofluorescence emissions, or the diffuse reflectance signals, or both from the tissue sample, and to produce photodetector signals representative of the detected said autofluorescence emissions, or the detected said diffuse reflectance signals, or both;
filtering the light emitted or reflected from the tissue sample resulting from each said sequential interrogation of the tissue sample;
processing the photodetector signals for each sequential application of the plurality of excitation lights, including producing an image representative of the photodetector signals produced by each sequential application of the plurality of excitation lights; and
analyzing the tissue sample using each image to identify the presence of diseased tissue within the tissue sample.

16. The method of claim 15, wherein the filtering step includes filtering the light emitted or reflected from the tissue sample to selectively pass a portion of the light emitted or reflected from the tissue sample associated with the one or more biomolecules of interest.

17. The method of claim 15, wherein the filtering step includes filtering the light emitted or reflected from the tissue sample to selectively pass a portion of the light emitted or reflected from the tissue sample associated with cellular or microstructural morphological information relating to the tissue sample.

18. The method of claim 15, further comprising filtering each of the excitation lights prior to each respective said excitation light interrogating the tissue sample.

19. The method of claim 15, wherein the one or more biomolecules of interest are associated with cancer.

20. The method of claim 19, wherein the cancer is one or more of breast cancer, liver cancer, bladder cancer, or colon cancer.

21. The method of claim 15, wherein the analyzing step includes identifying the presence of the one or more biomolecules of interest.

22. The method of claim 15, wherein the analyzing step includes providing cellular or microstructural morphological information.

23. The method of claim 15, wherein the analyzing step includes using stored empirical data to evaluate the plurality of the images.

24. The method of claim 15, wherein the analyzing step includes using a classifier to evaluate the plurality of the images.

25. The method of claim 15, wherein the tissue sample is ex-vivo sample during intraoperative surgery.

26. The method of claim 15, wherein the tissue sample is tissue biopsy.

27. The method of claim 15, wherein the tissue sample is used in conjunction with a mammogram for tissue biopsy diagnosis.

28. The method of claim 15, wherein the tissue sample is used for triaging surgical specimens in a pathological setting.
